(19) United States
(12) Patent Application Publication
(10) Pub. No.: US 2025/0109078 A1
(43) Pub. Date: Apr. 3, 2025

(54) METHOD FOR PRODUCTION OF AMMONIUM PHOSPHATE/CELLULOSE COATED NUTRIENT COMPOSITION

(71) Applicant: SABIC AGRI-NUTRIENTS COMPANY, JUBAIL (SA)

(72) Inventors: Aghaddin Khanlar MAMEDOV, Bengaluru (IN); Bedour AL-SABBAN, Bengaluru (IN); Ridha BELLA, Bengaluru (IN); Mohamed AL-RABHI, Bengaluru (IN)

(73) Assignee: SABIC AGRI-NUTRIENTS COMPANY, JUBAIL (SA)

(21) Appl. No.: 18/725,348

(22) PCT Filed: Dec. 23, 2022
(86) PCT No.: PCT/EP2022/087743

§ 371 Date: Jun. 28, 2024

Related U.S. Application Data
(60) Provisional application No. 63/295,627, filed on Dec. 31, 2021.

(51) Int. Cl. C05G 5/40; C05B 7/00; C05F 11/00

(52) U.S. Cl. CPC C05G 5/40; C05B 7/00; C05F 11/00

(57) ABSTRACT

An ammonium cellulose phosphate fertilizer and methods for producing and using the same. The ammonium cellulose phosphate fertilizer includes ammonium cellulose phosphate and ammonium phosphate encapsulated within the ammonium cellulose phosphate. The ammonium cellulose phosphate fertilizer may also include ammonium phosphate absorbed on the surface of ammonium cellulose phosphate.

### CROSS REFERENCE TO RELATED APPLICATIONS

None

### BACKGROUND OF THE INVENTION

### A. Field of the Invention

This invention is in the field of dual release fertilizers. Generally, it concerns an ammonium cellulose phosphate fertilizer composition that includes ammonium cellulose phosphate and ammonium phosphate encapsulated within the ammonium cellulose phosphate and in some instances absorbed on the surface of the ammonium cellulose phosphate. Methods of production and use are also disclosed.

### B. Description of Related Art

The primary nutrients provided in soil fertilizers are phosphorous, potassium, and nitrogen. Phosphorous is typically applied in the form of calcium phosphate (Ca₃(PO₄)₂) or superphosphate (Ca(H₂PO₄)₂), while potassium is commonly provided as potassium chloride (KCl), potassium sulfate (K₂SO₄), or potassium nitrate (KNO₃). Nitrogen is customarily applied in the form of urea (H₂NCONH₂), or the inorganic salts ammonium nitrate (NH₄NO₃) and ammonium sulfate ((NH₄)₂SO₄). These compounds are often blended with other fertilizer nutrients in order to provide a balanced nutrition for plant growth. The primary advantage of fertilizer nutrient blending is the ability to produce high-grade fertilizers whose compositions may be adjusted based on individual crop requirements.

Generally, salts are more easily dissolved in water than organic compounds. Urea is a small, hygroscopic organic compound that is an exception to this rule. Urea is often blended with other fertilizer ingredients in order to reduce urea loss resulting from rapid dissolution in water. Other fertilizer ingredients that are commonly blended with urea include acids, bases, and inorganic salts. Some fertilizer ingredients, however, are not blended with urea due to chemical incompatibility. When the highly hygroscopic urea is blended with certain salts, the resulting mixture easily absorbs moisture and becomes wet. Magnesium sulfate (MgSO₄), for example, is usually encountered in the form of a hydrate (MgSO₄·nH₂O), where n is an integer from 1 to 11. The most common form of magnesium sulfate is the heptahydrate (MgSO₄·7H₂O), and a blend of this compound and urea forms the magnesium sulfate-urea compound (MgSO₄)₅₋₆(H₂NCONH₂)·2H₂O. This compound is exceptionally hygroscopic and cannot be employed in solid fertilizers.

Various techniques have been employed to slow down or reduce nutrient loss in fertilizers. IN201841005012A discloses a crosslinked lignocellulose carrier that is imbued with additional nutrients and modified by reaction with calcium peroxide. IN201841005030A discloses a sustained release fertilizer that includes lignin or a cellulose ester. U.S. 2011/0296887 discloses a particulate-based method involves absorption of fertilizer nutrients on hydroxyapatite phosphate nanoparticles. CA2883269C discloses a cellulose-based fertilizer that has been treated with an amino compound and carbon dioxide. CN103755498B discloses a fertilizer that may include a cellulose-based carrier component, including hydroxypropyl cellulose and carbonxymethyl cellulose. CN104086268B discloses a fertilizer that is coated with an adhesive coating. The adhesive coating can be carboxymethyl cellulose, sodium silicate, or a combination thereof. CN109369265A discloses a coated fertilizer that includes cellulose as the coating material. WO 2015/145442 discloses a technique that involves the use of nano-crystalline cellulose as an agri-nutrient absorbent. Belosinschi et al. Phosphorylation of Cellulose in the Presence of Urea—Mechanism of Reaction and Reagent Impact, Research Square 2021 discloses a urea fertilizer that includes phosphorylated cellulose. Perez-Garcia et at Controlled Release of Ammonium Nitrate from Ethylcellulose Coated Formulations, Ind. Eng. Chem. Res. 2007, 46, 10, 3304-3311 discloses a controlled release ammonium nitrate fertilizer that is coated with ethylcellulose. These fertilizer compositions include a polymeric component that provides a sustained nutrient release, however, the fertilizers do not provide both a sustained and immediate release of agri-nutrients. There exists a need in the agri-nutrient industry for environmentally-friendly methods and compositions that provide a well-balanced and regulated nutrient release.

### SUMMARY OF THE INVENTION

A fertilizer composition is disclosed herein that employs a biodegradable polymer nutrient scaffold which acts as a nutrient delivery platform. Some nutrients are chemically bound to the polymer. Additional nutrients are encapsulated within and absorbed onto the surface of the fertilizer. By employing a biodegradable polymer scaffold that may utilize nutrient encapsulation, nutrient chemical bonding, and surface absorption of nutrients, the inventors have discovered a way to provide an environmentally safe, fertilizer composition that provides rapid and sustained nutrient release. Nutrients that are absorbed onto or encapsulated by the polymer scaffold exhibit a relatively fast release profile, and serve as the rapid-release components. Nutrients that are chemically bonded to the polymer scaffold exhibit a slower, more sustained release profile. The end result is a fertilizer with a biodegradable polymeric backbone that provides a bi-phasic release profile of nutrients. The biodegradable polymeric backbone is compatible with soil and crops, and is derived from a renewable source.

In one aspect, a method to produce a dual-release, cellulosic nitrogen and phosphorous (NP) fertilizer composition is disclosed. The method may include the steps of providing a cellulosic material, reacting the cellulosic material with phosphoric acid to produce a phosphorylated cellulosic material, wherein at least a portion of the cellulosic material hydroxyl groups are phosphorylated, and reacting the phosphorylated cellulosic material with a source of ammonia to produce an ammonium cellulose phosphate. In some aspects, the ammonium cellulose phosphate is produced in the form of a gel. The ammonium cellulose phosphate is then dried to provide a solid fertilizer composition. In some aspects solid fertilizer composition further comprises ammonium phosphate encapsulated within the ammonium cellulose phosphate. In some aspects solid fertilizer composition further comprises ammonium phosphate absorbed onto the surface of the ammonium cellulose phosphate. In some aspects, the fertilizer composition is provided in the form of a powder, prill, granule, or pellet. In some aspects, the fertilizer composition does not contain urea

In some aspects, the cellulosic material is free of lignin. In some aspects, the cellulosic material is cellulose. In some aspects the cellulosic material is jute, hemp, corn, flax, rice, wheat straw, sisal, wood pulp, cotton fibers, cellulose, etc., or a combination thereof. In some aspects, a weight ratio of phosphoric acid to cellulose ranges from 1:1 to 5:1. The weight ratio of phosphoric acid to cellulose may be any one of, less than, greater than, or between 1:1, 2:1, 3:1, 4:1, 5:1, or any range derivable therein. In some aspects, the phosphoric acid is an aqueous solution comprising phosphoric acid. In some aspects, the phosphoric acid is an aqueous solution comprising 85% by weight of phosphoric acid. In some aspects, wherein the step of reacting the cellulosic material with phosphoric acid comprises combining a solution of cellulose with a phosphoric acid solution. In some aspects, the step of reacting the cellulosic material with phosphoric acid is performed at a temperature ranging from about 100° C. to about 200° C., preferably from about 125° C. to about 175° C., more preferably at a temperature of about 150° C. The step of reacting the cellulosic material with phosphoric acid may be performed at a temperature of any one of, less than, greater than, between, or any range thereof of 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150° C.

In some aspects, the step of reacting the phosphorylated cellulosic material with a source of ammonia comprises combining a solution of ammonium hydroxide with a solution comprising the phosphorylated cellulosic material. In some aspects, the step of reacting the phosphorylated cellulosic material with a source of ammonia comprises combining a solution of ammonium with a solution comprising the phosphorylated cellulosic material. In some aspects, the step of reacting the phosphorylated cellulosic material with a source of ammonia comprises combining ammonia gas with a solution comprising the phosphorylated cellulosic material. The source of ammonia may be reacted with the phosphorylated cellulosic material at a ratio of any one of, less than, greater than, between, or any range thereof of 10:1 to 1:10 moles ammonia or ammonium to moles of phosphoric acid added in the reaction of the cellulosic material with phosphoric acid. In some aspects, the source of ammonia may be reacted with the phosphorylated cellulosic material at a ratio of any one of, less than, greater than, between, or any range thereof of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10 moles ammonia or ammonium to moles of phosphoric acid or any range therein. In some instances, the ratio is any one of, less than, greater than, between, or any range thereof of 5:1, 4.5:1, 4:1, 3.5, 3:1, 2.5:1, 2:1, 1.5:1, 1:1, 1:1.5, 1:2 moles ammonia or ammonium to moles of phosphoric acid or any range therein. In some aspects, the step of reacting the phosphorylated cellulosic material with a source of ammonia is performed at a temperature ranging from about 70° C. to about 170° C., preferably from about 95° C. to about 145° C., more preferably at a temperature of about 120° C. The step of reacting the phosphorylated cellulosic material with a source of ammonia is performed at a temperature of any one of, less than, greater than, between, or any range thereof of 70° C. to about 170° C.

In some aspects, the method further comprises the step of adding an additional nutrient to the fertilizer composition. The additional nutrient may be added before, during, or after formation of the ammonium cellulose phosphate and ammonium phosphate encapsulated within the ammonium cellulose phosphate. The additional nutrient may be, but is not limited to, potassium, magnesium, chloride, sulfate, superphosphates, rock phosphate, potash, sulfate of potash (SOP), muriate of potash (MOP), kieserite, carnallite, magnesite, dolomite, boric acid, boron, copper, iron, manganese, molybdenum, zinc, selenium, silicon, free calcium, elemental sulfur, neem oil, seaweed extract, bio-stimulants, char, ashes from incineration of animal waste or animal tissues, or any combination thereof.

In some aspects, the ratio of phosphoric acid to ammonia source employed in the production of the fertilizer may be adjusted to regulate the pH of soil. For example, the amount of ammonia source employed in the fertilizer production may be increased in order to increase the ammonia content in the final fertilizer product. When the fertilizer is added to soil, the increased amount of ammonia within the fertilizer will increase the pH of the soil to a value that is greater than soil treated with a fertilizer having lower ammonia content. Along the same lines, phosphoric acid content may be increased to lower the pH of the soil.

In some aspects, the process of forming the fertilizer composition may include adding a coating on the surface of the fertilizer composition. In some instances, the coating may contain nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, microorganisms, etc. or any combination thereof. Non-limiting examples of a coating include a commercially available coating, an oil, a fertilizer, a micronutrient, talc, a seaweed and/or seaweed extract, a wax, a bacteria, etc. In some instances, the coating may contain surfactants. In some instances, the coating contains a wax, surfactants, and/or an amine-based compound. The coating may be applied to the fertilizer composition, such as the fertilizer composition in the form of a powder, prill, granule, or pellet before drying, during drying of the granule, and/or after drying of the granule. The coating may be applied to the fertilizer composition by spraying, pouring, mixing, blending, etc. A fluid bed sprayer or coater, a liquid spray mixer, a rotating drum or pan, spray coating at discharge point, a paddle mixer, etc. may be used.

One aspect is directed to a dual-release, cellulosic nitrogen and phosphorous (NP) fertilizer composition formed by the method to produce a dual-release, cellulosic nitrogen and phosphorous (NP) fertilizer composition described herein or by another method. The dual-release, cellulosic nitrogen and phosphorous (NP) fertilizer composition may contain or be an ammonium cellulose phosphate and ammonium phosphate encapsulated within the ammonium cellulose phosphate. In some aspects, the cellulosic fertilizer further comprises ammonium phosphate on the surface of the ammonium cellulose phosphate. In some aspects, the fertilizer is in the form of a powder, prill, granule, or pellet. In some aspects, the fertilizer comprises at least one additional nutrient. The at least one additional nutrient may be, but is not limited to, potassium, magnesium, chloride, sulfate, superphosphates, rock phosphate, potash, sulfate of potash (SOP), muriate of potash (MOP), kieserite, carnallite, magnesite, dolomite, boric acid, boron, copper, iron, manganese, molybdenum, zinc, selenium, silicon, free calcium, elemental sulfur, neem oil, seaweed extract, bio-stimulants, char, ashes from incineration of animal waste or animal tissues, or any combination thereof. In some aspects, the at least one additional nutrient is encapsulated within the ammonium cellulose phosphate. In some aspects, the fertilizer comprises the at least one additional nutrient absorbed on the surface of the ammonium cellulose phosphate.

In some aspects, the nitrogen content in the fertilizer composition is in the range of 15 wt. % to 25 wt. %, such as any one of, less than, greater than, between, or any range thereof of 15, 16, 17, 18, 19, 20, 21, 22, 23, 24, or 25 wt. %. In some aspects, the phosphorus content in the fertilizer composition is in the range of 15 wt. % to 25 wt. %, such as any one of, less than, greater than, between, or any range thereof of 15, 16, 17, 18, 19, 20, 21, 22, 23, 24, or 25 wt. %.

In some aspects, the fertilizer composition contains a coating on the ammonium cellulose phosphate and ammonium phosphate encapsulated within the ammonium cellulose phosphate, such as a core of ammonium cellulose phosphate and ammonium phosphate encapsulated within the ammonium cellulose phosphate and a shell coating. In some aspects, the fertilizer composition contains within a matrix of the coating the ammonium cellulose phosphate and ammonium phosphate encapsulated within the ammonium cellulose phosphate, such as an extruded fertilizer granule.

In some aspects, the fertilizer composition contains the ammonium cellulose phosphate as a matrix containing ammonium phosphate and optionally other ingredients such as additional nutrient(s), inhibitor(s), alkali material, acidic material, etc. In some aspects, the fertilizer composition contains a core with a coating of the ammonium cellulose phosphate and ammonium phosphate encapsulated within the ammonium cellulose. The core may contain nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, microorganisms, etc. or any combination thereof.

One aspect is directed to a method for fertilizing agricultural crops comprising applying the dual-release, fertilizer composition. The dual-release, fertilizer composition may be applied to a plant, soil, water, or any combination thereof.

The amount of water in the fertilizer composition after drying may be less than 0.6 wt. %, 0.5 wt. %, 0.4 wt. %, 0.3 wt. %, 0.2 wt. %, 0.1 wt. %, or any amount or range thereof or there between. The fertilizer composition may optionally contain an alkali material. The alkali material may be present at between about 0.2 wt. % to 7 wt. % of the fertilizer composition. The alkali material may be present at any one of, less than, greater than, between, or any range thereof of 0.2, 0.3, 0.4, 0.5, 0.6, 0.7, 0.8, 0.9, 1, 2, 3, 4, 5, 6, or 7 wt. %. In some aspects, the base may be MgO.

The fertilizer composition may optionally contain an inhibitor. The inhibitor may be a nitrification inhibitor and/or a urease inhibitor. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. Suitable nitrification inhibitors include DMPP, DCD, TU, nitrapyrin, 5-ethoxy-3-trichloromethyl-1,2,4-thiadiazol, AM, MBT, or ST, or a combination thereof. The urease inhibitor may be present at any one of, less than, greater than, between, or any range thereof of 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1 wt. %, such as 0.01 wt. % to 0.2 wt. %. The nitrification inhibitor may be present at any one of, less than, greater than, between, or any range thereof of 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt. %, such as 2 wt. % to 20 wt. %.

The following includes definitions of various terms and phrases used throughout this specification.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, urea calcium sulfate adduct, one or more superphosphates, binary NP fertilizers, binary NK fertilizers, binary PK fertilizers, NPK fertilizers, molybdenum, zinc, copper, boron, cobalt, and/or iron. In some aspects, fertilizers include agents that enhance plant growth and/or enhance the ability for a plant to receive the benefit of a fertilizer, such as, but not limited to biostimulants, urease inhibitors, and nitrification inhibitors.

The term “nutrient” is defined as a chemical element or substance used for the normal growth and development of a plant. Non-limiting examples of nutrients include N, P, K, Ca, Mg, S, B, Cu, Fe, Mn, Mo, Zn, Se, and Si or compounds thereof.

The term “granule” can include a solid material. A granule can have a variety of different shapes, non-limiting examples of which include a spherical, a puck, an oval, a rod, an oblong, or a random shape. The term “prill” refers to a solid globule of a substance formed by the congealing of a liquid. The term “pellet” refers to a rounded, compressed mass of fertilizer. The term “powder” refers to dry particles produced by the grinding, crushing, or disintegration of a fertilizer composition.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The ammonium cellulose phosphate fertilizer composition and methods of producing the ammonium cellulose phosphate fertilizer composition of the present invention can “comprise,” “consist essentially of,” or “consist of” particular ingredients, components, compositions, steps, etc. disclosed throughout the specification. With respect to the transitional phase “consisting essentially of,” in one non-limiting aspect, a basic and novel characteristic of the ammonium cellulose phosphate fertilizer composition of the present invention is the presence of ammonium phosphate encapsulated within and absorbed onto the surface of the ammonium cellulose phosphate fertilizer composition.

### DETAILED DESCRIPTION OF THE INVENTION

A method for producing a dual-release, fertilizer composition comprising a combination of ammonium cellulose phosphate and ammonium phosphate encapsulated within the ammonium cellulose phosphate is disclosed. The dual-release, fertilizer composition includes both an ammonium cellulose phosphate component and an ammonium phosphate component. The ammonium phosphate is encapsulated within the ammonium cellulose phosphate and may also be provided on the surface of the ammonium cellulose phosphate. The encapsulated ammonium phosphate component may readily dissolve in water and constitutes a quick-release component of the dual-release fertilizer. The ammonium cellulose phosphate component may have a plurality of ammonium phosphate groups, with the phosphate groups covalently bonded to the polymeric cellulose backbone. The covalent bond between cellulose and phosphate is relatively durable and may be broken over time and impart a delayed-release functionality for phosphate and nitrogen. Additional advantages of this fertilizer composition include the ability to provide non-urea based nitrogen, as urea may decrease the storage stability of a fertilizer, the ability to biodegrade, and the sustainable sourcing for components of the fertilizer.

A cellulosic fertilizer contains cellulose or cellulose derivatives such as ammonium cellulose phosphate. Cellulose is a linear polymeric organic compound with the formula (C₆H₁₀O₅)ₙ where n is generally several hundred to many thousands. D-glucose units are linked to each other through a β(1→4) glycosidic linkage that may be hydrolyzed in the presence of water to provide smaller cellulose chains and free glucose monosaccharides. Cellulose may also undergo biodegradation by microorganisms. Cellulase enzymes in microorganisms in the soil can break down cellulose into smaller cellulose chains and free glucose monosaccharides. Importantly, cellulose is primarily obtained from natural sources such as wood pulp and other plant sources, and constitutes a renewable scaffold for the fertilizer composition disclosed herein.

### A. Process to Produce Ammonium Cellulose Phosphate Fertilizer

A process for producing ammonium cellulose phosphate and ammonium phosphate dual-release, fertilizer composition is disclosed. In some aspects, the process may be produced by the following reaction steps:

a) Cel-OH+PO₄H₃→Cel-PO₄H₂+H₂O

In step a) above, a cellulosic material (Cel-OH) is first provided. The “Cel-OH” nomenclature employed herein depicts the polymeric cellulose backbone “Cel-” made up of a plurality of glucose units and hydroxyl groups “—OH” of the glucose units. A single “—OH” group is used above for clarity, however, a typical cellulose molecule will include hundreds to thousands of hydroxyl groups. The cellulosic material may be combined with phosphoric acid, for example, dissolving cellulose in phosphoric acid. Upon heating a mixture of cellulose and phosphoric acid, a dehydrative coupling reaction occurs between a cellulose hydroxyl group and the phosphoric acid molecule to provide cellulose phosphate “Cel-PO₄H₂”. On average, less than one, one, or more than one (e.g., two) cellulose hydroxyl group per glucose unit may react with a phosphoric acid molecule. The mixture may be heated at a temperature ranging from about 100° C. to about 200° C., preferably from about 125° C. to about 175° C., more preferably at a temperature of about 150° C. The reaction may be performed in a sealed vessel to prevent loss of water. One molecule of water “H₂O” is produced for every dehydrative coupling reaction between cellulose and phosphoric acid. In some aspects, the cellulose phosphate is in the form of a gel.

b) Cel-OH+H₃PO₄→Cel-OH (+free H₃PO₄)

b2) Cel-PO₄H₂+H₃PO₄→Cel-PO₄H₂ (+free H₃PO₄)

In addition to the dehydrative coupling between cellulose and phosphoric acid, some free phosphoric acid may remain unreacted and exist within the gelatinous cellulose phosphate (as depicted in steps b and b2 above, respectively).

c) Cel-PO₄H₂₊₂ NH₃→Cel-PO₄(NH₄)₂

alternative c) Cel-PO₄H₂₊₂ NH₄OH→Cel-PO₄(NH₄)₂₊₂ H₂O

After formation of cellulose phosphate, a source of ammonia is added to the mixture. In some aspects, the source of ammonia is a solution of ammonium hydroxide. In some aspects, the source of ammonia is ammonia gas or liquid ammonia obtained by cooling of ammonia gas below its boiling point (−33° C.). In some aspects, the source of ammonia is a solution of ammonium. As ammonia is more basic than phosphate, ammonia will abstract protons from cellulose phosphate “Cel-PO₄H₂” to provide ammonium cellulose phosphate “Cel-PO₄(NH₄)₂” as depicted in step c above. When ammonium hydroxide is employed as the source of ammonia (alternative step c above), hydroxide will abstract protons from cellulose phosphate to provide water and cellulose phosphate.

d) free, unbound H₃PO₄+3 NH₃→+free, unbound (NH₄)₃PO₄

d2) free, unbound H₃PO₄+3 NH₄OH→free, unbound (NH₄)₃PO₄+3 H₂O

In addition to the reactions between cellulose phosphate and an ammonia source depicted in step c and alternative c above, some ammonia may react with free phosphoric acid that exists within the gelatinous cellulose phosphate to produce free, unbound ammonium phosphate (step d). Alternatively, or in addition to this reaction, ammonium hydroxide may abstract protons from free, unbound phosphoric acid that exists within the gelatinous cellulose phosphate to produce water and ammonium phosphate (step d2).

The reactions depicted above provide a fertilizer that includes N and P nutrients (in the form of ammonium and phosphate) that may be chemically bonded to and encapsulated within the cellulosic carrier material. Physically absorbed ammonium phosphate may be found on the surface of and in pore cavities of the cellulosic material. In some aspects, the reaction depicted above provides ammonium cellulose phosphate in the form of a gel. Water may then be removed from this gelatinous material to provide ammonium cellulose phosphate in solid form. Different techniques can be employed before, during, or after drying to provide the solid ammonium cellulose phosphate fertilizer in powder, prill, granule, or pellet form.

These and other non-limiting aspects of the present invention are discussed in further detail in the following sections.

### B. Solid Forms of Fertilizer Composition

The dried, solid fertilizer composition produced can, in some instances, contain low amounts of moisture. The free-moisture content of the dried, solid fertilizer composition may be less than 0.6 wt. %, less than 0.5 wt. % water or 0.25 wt. % to less than 0.6 wt. % water. In some instances, the free moisture content is, is less than, is more than, or is between 0.5, 0.4, 0.3, 0.2, 0.1, or 0 wt. %, or any range thereof.

The dried, solid fertilizer composition may be produced in powder, prill, granule, or pellet form. In certain non-limiting aspects, the powder may comprise particles having an average particle size that is, is less than, is more than, or is between 1, 2, 3, 4, 5, 6, 7, 8, 9, 10, 11, 12, 13, 14, 15, 20, 30, 40, 50, 60, 70, 80, 90, 100, 200, 300, 400, 500, 600, 700, 800, or 900 micrometers or any range thereof. In some embodiments, the particles may be elongated particles or may be substantially spherical particles or other shapes, or combinations of such shapes. Non-limiting examples of shapes include a sphere, a puck, an oval, a rod, an oblong, or a random shape.

The dried, solid fertilizer composition may in some instances contain a coating on the surface of the fertilizer composition. In some instances, the coating may include nutrients for a plant, inhibitors of urea hydrolysis and/or nitrification, agents to slow or increase the rate of degradation of the granule and/or fertilizers, agents to repel moisture and/or provide a hydrophobic layer, agents that decrease or increase the reactivity of the granule and/or fertilizers, agents that provide additional benefits to plants, agents that increase the stability and/or crush strength of the granule and/or fertilizers, pH buffering agents, drying agents, biostimulants, microorganisms, etc. or any combination thereof. The coating may be a commercially available coating, an oil, a fertilizer, a micronutrient, talc, a seaweed and/or seaweed extract, a bacteria, a wax, etc. In some instances, the coating may contain surfactants. In some instances, the coating contains a wax, surfactants, and/or an amine-based compound.

In some aspects, the fertilizer composition contains a coating on the ammonium cellulose phosphate and ammonium phosphate encapsulated within the ammonium cellulose phosphate, such as a core of ammonium cellulose phosphate and ammonium phosphate encapsulated within the ammonium cellulose phosphate and a shell coating. In some aspects, the fertilizer composition contains within a matrix of the coating, e.g., homogenously distributed therein, the ammonium cellulose phosphate and ammonium phosphate encapsulated within the ammonium cellulose phosphate, such as an extruded fertilizer granule.

In some aspects, the fertilizer composition contains the ammonium cellulose phosphate as a matrix containing ammonium phosphate and optionally other ingredients such as additional nutrient(s), inhibitor(s), alkali material, acidic material, biostimulant(s), microorganism(s), etc. In some aspects, the fertilizer composition contains a core with a coating of the ammonium cellulose phosphate and ammonium phosphate encapsulated within the ammonium cellulose. The core may contain nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, microorganisms, etc. or any combination thereof.

### C. Blended or Compounded Fertilizer Compositions

The fertilizer composition disclosed herein may also be included in a blended or compounded fertilizer composition comprising other fertilizers, such as other fertilizer granules. Additional fertilizers may be chosen based on the particular needs of certain types of soil, climate, or other growing conditions to maximize the efficacy of the fertilizer composition in enhancing plant growth and crop yield. The other fertilizer granules may be granules of urea, single super phosphate (SSP), triple super phosphate (TSP), ammonium sulfate, monoammonium phosphate (MAP), diammonium phosphate (DAP), muriate of potash (MOP), and/or sulfate of potash (SOP), and the like.

In one aspect, the fertilizer composition may comprise one or more inhibitors. The inhibitor may be a urease inhibitor or a nitrification inhibitor, or a combination thereof. In one aspect, a urease inhibitor and a nitrification inhibitor are included. In one aspect, the inhibitor may be a urease inhibitor. Suitable urease inhibitors include, but are not limited to, N-(n-butyl) thiophosphoric triamide (NBTPT) and phenylphosphorodiamidate (PPDA). In one aspect, the fertilizer composition may comprise NBTPT or PPDA, or a combination thereof. In another aspect, the inhibitor may be a nitrification inhibitor. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In one aspect, a nitrification inhibitor may comprise DMPP, DCD, TU, nitrapyrin, 5-ethoxy-3-trichloromethyl-1,2,4-thiadiazol, AM, MBT, or ST, or a combination thereof. In one aspect, the fertilizer composition may comprise NBTPT, DMPP, TU, DCD, PPDA, nitrapyrin, 5-ethoxy-3-trichloromethyl-1,2,4-thiadiazol, AM, MBT, or ST, or a combination thereof.

### D. Method of Using the Fertilizer Composition

The fertilizer composition of disclosed herein can be used in methods of increasing the amounts of nitrogen and phosphorus in soil and of enhancing plant growth. Such methods may include applying to the soil an effective amount of a composition comprising the fertilizer composition disclosed herein. The method may include increasing the growth and yield of crops, trees, ornamentals, etc. such as, for example, palm, coconut, rice, wheat, corn, barley, oats, and soybeans. The method may include applying the fertilizer composition disclosed herein to at least one of a soil, an organism, a liquid carrier, a liquid solvent, etc.

Non-limiting examples of plants that may benefit from the fertilizer disclosed herein include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the fertilizer composition disclosed herein may be ascertained by measuring the amount of nitrogen, phosphorus, or nitrogen and phosphorus in the soil at various times after applying the fertilizer composition to the soil. It is understood that different soils have different characteristics, which may affect the stability of the nitrogen in the soil. The effectiveness of a fertilizer composition may also be directly compared to other fertilizer compositions by doing a side-by-side comparison in the same soil under the same conditions.

In one aspect, the fertilizer composition disclosed herein may have a density that is greater than water. This may allow the granules and/or fertilizers to sink in water rather than float. This may be especially beneficial in instances where application is intended to a crop that is at least partially or fully submerged in water. A non-limiting example of such a crop is rice, as the ground in a rice paddy is typically submerged in water. Thus, application of fertilizer composition to such crops may be performed such that the granules and/or fertilizer are homogenously distributed on the ground that is submerged under water. By comparison, granules and/or fertilizers that have a density that is less than water would have a tendency to remain in or on the water surface, which could result in washing away and/or coalescence of the granules and/or fertilizers, either of which would not achieve homogenous distribution of the granules and/or fertilizers to the ground that is submerged under water.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### A. Example 1—Producing Cellulosic Fertilizer From Cellulose

1. Phosphorylation of cellulose. In an exemplary reaction, 100 g of cellulose, with an average molecular weight of a glucose unit number of 162, is combined with 181.5 g of H₃PO₄ (85 wt. % in water) and the reaction mixture was heated to 150° C. This combination of cellulose and phosphoric acid amounts provides cellulose phosphate in which approximately two hydroxyl groups per glucose monomer are converted into phosphate groups. This reaction is expected to consume approximately 60.5 g of the phosphoric acid and provides a mixture that is gelatinous. The remaining phosphoric acid, expected to be approximately 121 g, becomes physically absorbed onto the cellulose phosphate produced.
Example 1A: Process for preparation of Phosphorylated cellulose: 12% Phosphoric acid (14.2 ml of H₃PO₄ with 176 ml of H₂O) was preheated at 50° C. for 2 hours' time and then reacted with 5 g of cellulose at atmospheric pressure with a rotating ramp of 300 rpm for 2 hours in an oil bath for 2 hours. A dense gel was obtained as a reaction product of cellulose with phosphoric acid. The obtained dense gel was then dried under vacuum at 80° C. and finely grounded.
Example 1B: Process for preparation of Phosphorylated cellulose: Same process of Example 1A was followed but without preheating of 12% Phosphoric acid (14.2 ml of H3PO4 with 176 ml of H₂O).

TABLE 1

| | 12% Phosphoric acid | | |
|---|---|---|---|
| | (14.2 ml H₃PO₄ + | Cellulose | Reaction |
| Example | 176 ml H₂O) | Amount (g) | conditions |
| 1A | 22 ml Preheated at | 5 | 2 hours/300 rpm at |
| | 50° C. for 30 min | | 50° C.(oil bath) |
| 1B | 22 ml of solvent not pre- | 5 | 2 hours/300 rpm at |
| | heated | | 50° C.(oil bath) |

2. Ammonization of cellulose phosphate. To the reaction mixture above is added 80.9 g of ammonium hydroxide solution (28-30 wt. % in water) and the resulting combination is heated at 120° C. This quantity of ammonium hydroxide is sufficient to react with the cellulose phosphate groups, as well as with the absorbed phosphoric acid. The result is a gelatinous mixture of ammonium cellulose phosphate and ammonium phosphate. This mixture is then dried to provide a fertilizer composition comprising ammonium cellulose phosphate and ammonium phosphate that is encapsulated within and absorbed on the surface of the polymeric ammonium cellulose phosphate. The final product comprises 18.3% N, 15.8% P, with 68% of the N and P present as absorbed and encapsulated ammonium phosphate.

1. A method for preparing a dual-release, cellulosic nitrogen and phosphorous (NP) fertilizer composition comprising:
providing a cellulosic material;
reacting the cellulosic material with phosphoric acid to produce a phosphorylated cellulosic material, wherein at least a portion of the cellulosic material hydroxyl groups are phosphorylated;
reacting the phosphorylated cellulosic material with a source of ammonia to produce ammonium cellulose phosphate; and
drying the ammonium cellulose phosphate to provide the fertilizer composition;
wherein the fertilizer composition comprises ammonium phosphate encapsulated within the ammonium cellulose phosphate.

2. The method of claim 1, wherein reacting the cellulosic material with phosphoric acid comprises combining a solution of cellulose with a phosphoric acid solution.

3. The method of claim 1, wherein the cellulosic material is reacted with the phosphoric acid at a weight ratio of 1:1 to 1:5.

4. The method of claim 1, wherein reacting the cellulosic material with phosphoric acid comprises reacting at a temperature from about 100° C. to about 200° C.

5. The method of claim 1, wherein the source of ammonia comprises a solution of ammonium hydroxide, a solution of ammonium, and/or ammonia gas.

6. The method of claim 1, wherein reacting the phosphorylated cellulosic material with the source of ammonia comprises reacting at a temperature ranging from about 70° C. to about 170° C.

7. The method of claim 1, wherein reacting the phosphorylated cellulosic material with a source of ammonia produces ammonium cellulose phosphate in the form of a gel.

8. The method of claim 1, wherein reacting the cellulosic material with the phosphoric acid produces the phosphorylated cellulosic material in the form of a gel.

9. The method of claim 1, wherein the fertilizer composition further comprises ammonium phosphate absorbed onto the surface of the fertilizer composition.

10. The method of claim 1, wherein the fertilizer composition is in the form of a powder, prill, granule, and/or pellet.

11. The method of claim 1, wherein the cellulosic material is free of lignin and/or wherein the cellulosic material is cellulose.

12. The method of claim 1, wherein the fertilizer composition further comprises an additional nutrient, wherein the additional nutrient is added before, during, or after formation of the ammonium cellulose phosphate.

13. The method of claim 1, wherein the fertilizer composition is free of urea.

14. A dual-release, cellulosic fertilizer comprising a combination of ammonium cellulose phosphate and ammonium phosphate encapsulated by the ammonium cellulose phosphate.

15. The dual-release, cellulosic fertilizer of claim 14, further comprising at least one additional nutrient selected from the group consisting of potassium, magnesium, chloride, sulfate, superphosphates, rock phosphate, potash, sulfate of potash (SOP), muriate of potash (MOP), kieserite, carnallite, magnesite, dolomite, boric acid, boron, copper, iron, manganese, molybdenum, zinc, selenium, silicon, free calcium, elemental sulfur, neem oil, seaweed extract, bio-stimulants, char, ashes from incineration of animal waste or animal tissues, or any combination thereof.

16. The dual-release, cellulosic fertilizer of claim 14, further comprising ammonium phosphate on the surface of the fertilizer composition.

17. The dual-release, cellulosic fertilizer of claim 14, wherein the dual-release, cellulosic fertilizer is in powder, prill, granule, or pellet form.

18. The dual-release, cellulosic fertilizer of claim 14, wherein the dual-release, cellulosic fertilizer is free of lignin.

19. The dual-release, cellulosic fertilizer of claim 14, further comprising ammonium phosphate absorbed onto a surface of the dual-release, cellulosic fertilizer.

20. The dual-release, cellulosic fertilizer of claim 14, wherein the dual-release, cellulosic fertilizer is free of urea.
